(19) United States
(12) Patent Application Publication
(10) Pub. No.: US 2020/0143573 A1
(43) Pub. Date: May 7, 2020

(54) ANTI-GLARE SYSTEM FOR AIRCRAFT

(71) Applicant: THE BOEING COMPANY, Chicago, IL (US)

(72) Inventors: John William Glatfelter, Kennett Square, PA (US); Matthew Scott Jarka, South Hill, WA (US)

(21) Appl. No.: 16/180,669

(22) Filed: Nov. 5, 2018

(51) Int. Cl. G06T 11/60; G06K 9/32; G02B 27/01; B64D 43/00

(52) U.S. Cl. CPC G06T 11/60; G06K 9/3233; B64D 47/08; B64D 43/00; G02B 2027/0118; G02B 27/017

(57) ABSTRACT

A plurality of image capturing devices capture the scene in front of the aircraft. Information regarding the three-dimensional geometry of the windscreen is used to “trim” the raw image data from the image capturing devices. The remaining image data in a “zone-of-interest” is processed to detect glare in the field-of-view visible through the windscreen. The trimming operation reduces the amount of time and processing resources needed to perform glare detection. Information regarding the position and viewpoint of the pilot and co-pilot are also provided to the glare reduction module. The glare reduction module generates a translucent overlay on the windscreen or OSTD for both the pilot and co-pilot to block or reduce the glare.

### TECHNICAL FIELD

The present disclosure relates generally to aircraft safety and, more particularly, to methods and apparatus for reducing glare in the field of view of the pilot and co-pilot.

### BACKGROUND

Modern commercial aircraft are equipped with sophisticated avionics and computer-assisted controls to help pilots with many common flight operations. Aircraft safety, however, still depends on the pilot's ability to see and react to traffic conditions, both when the aircraft is in-flight and taxiing on the ground. The presence of glare in the pilot's field-of-view can impair the pilot's ability to process the visual scene and creates a safety hazard. Glare can originate from many sources. In addition to direct sun glare, reflections from buildings and solar installations are a common problem. When operating at night, glare from man-made light sources may cause a pilot to temporarily lose vision. Also, light from laser pointing devices may temporarily blind a pilot.

### SUMMARY

According to embodiments of the present disclosure, an optical see-through display (OSTD) is used as part of an anti-glare system to reduce the glare in the field-of-view of a pilot. The OSTD allows a pilot to view the environment around the aircraft using their natural vision. An anti-glare system detects the presence of glare in the field-of-view of the pilot and generates a shading overlay on the OSTD to block or reduce the glare.

According to one aspect, a plurality of image capturing devices capture the scene in front of the aircraft. Information regarding the three-dimensional geometry of the windscreen of the aircraft is used to “trim” the raw image data from the image capturing devices. The remaining image data in a “zone-of-interest” is processed to detect glare in the pilots' field-of-view visible through the windscreen. The trimming operation reduces the amount of time and processing resources needed to perform glare detection.

### BRIEF DESCRIPTION OF THE DRAWNGS

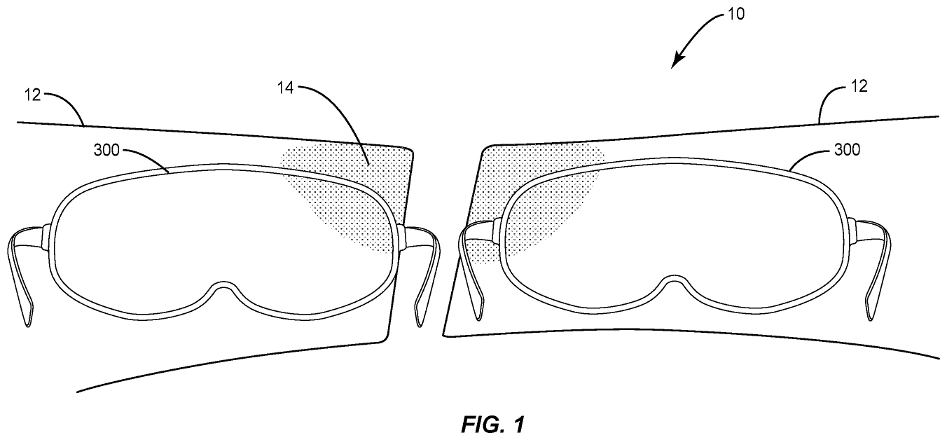

FIG. 1 illustrates a view from inside the flight deck in an aircraft without glare reduction.

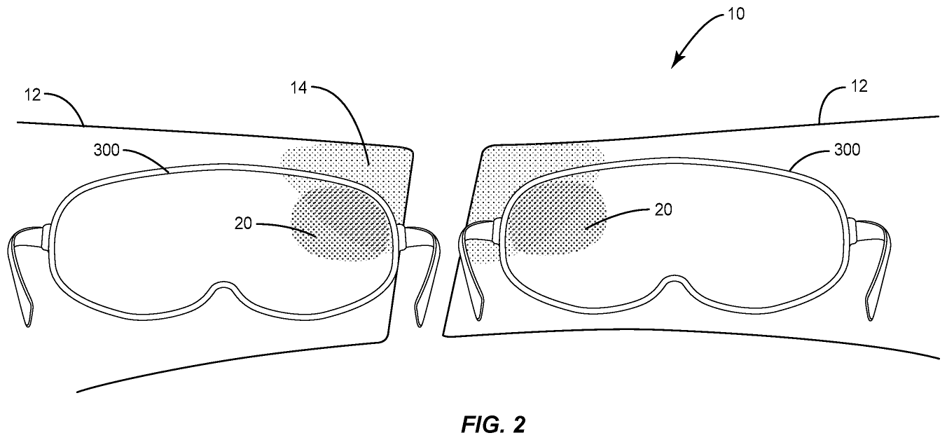

FIG. 2 illustrates a view from the flight deck of an aircraft with glare reduction.

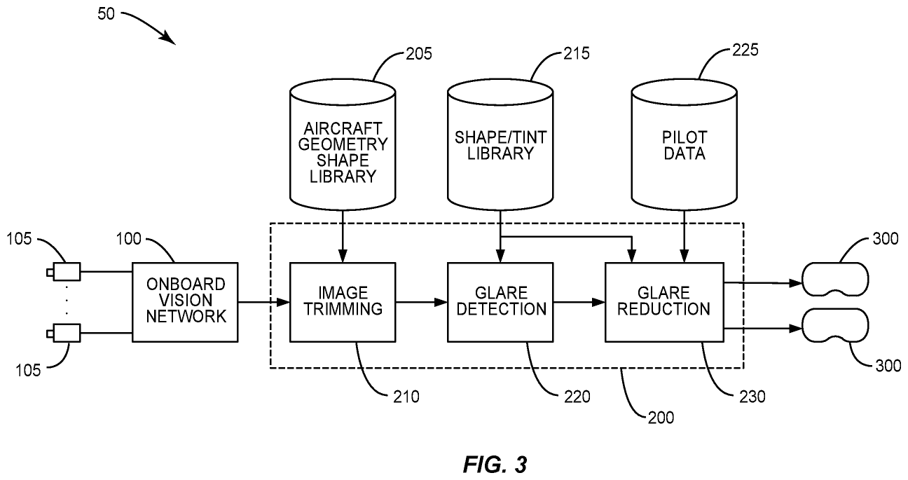

FIG. 3 illustrates an anti-glare system according to an embodiment.

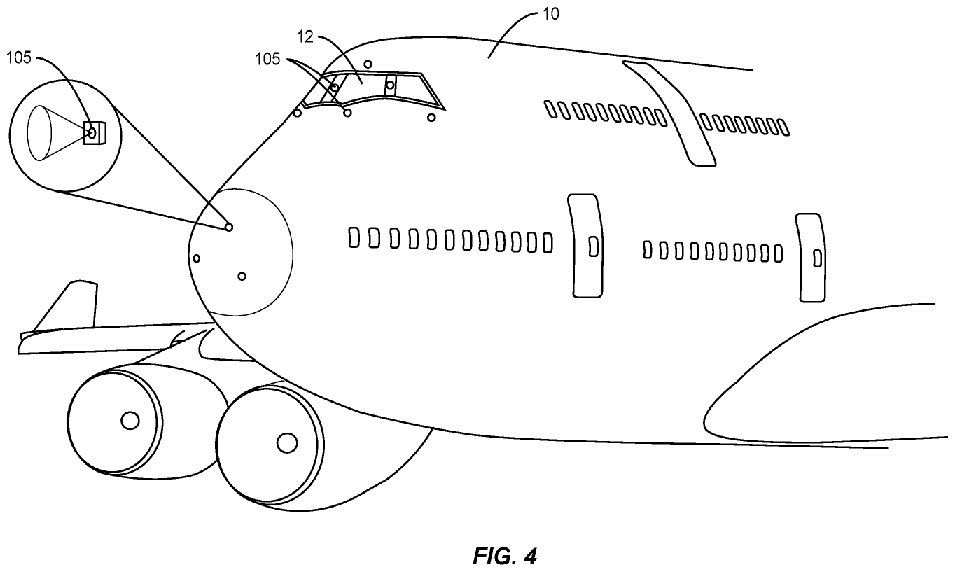

FIG. 4 is a schematic view showing one arrangement of image capturing devices relative to the windscreen of an aircraft.

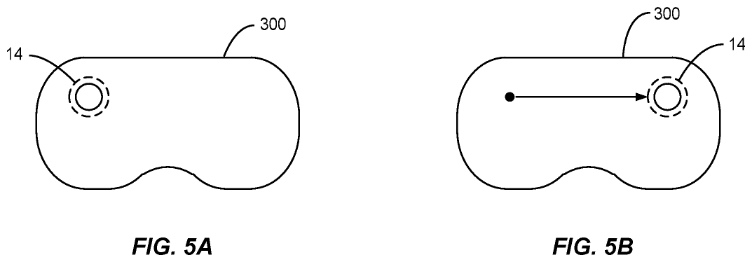

FIGS. 5A and 5B are schematic diagrams showing the position of glare on a head-mounted OSTD.

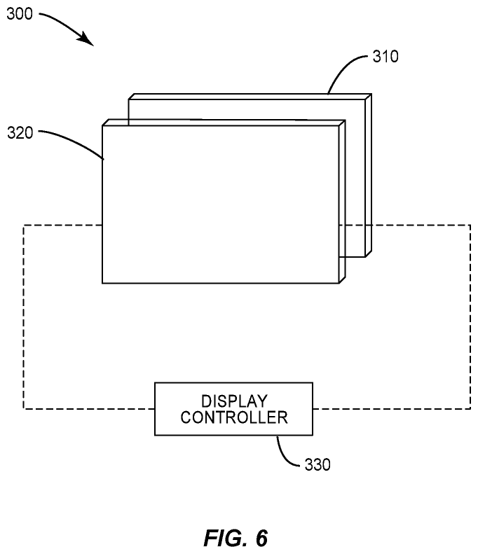

FIG. 6 is a schematic diagram of an OSTD with a shading layer for generating an overlay to block or reduce glare.

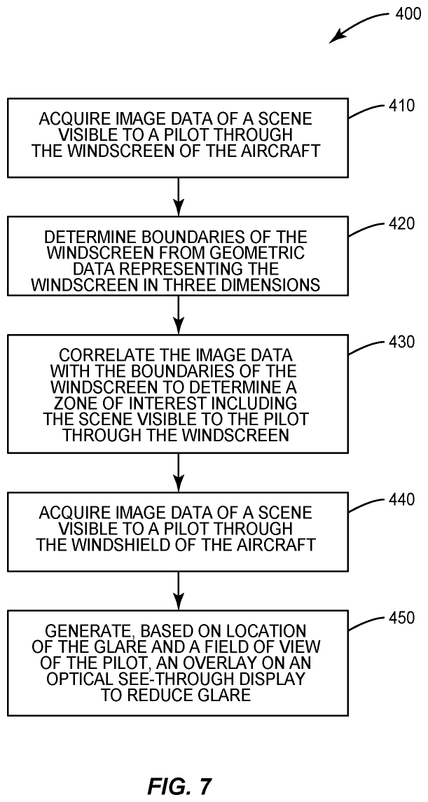

FIG. 7 illustrates an exemplary method for reducing glare on an OSTD.

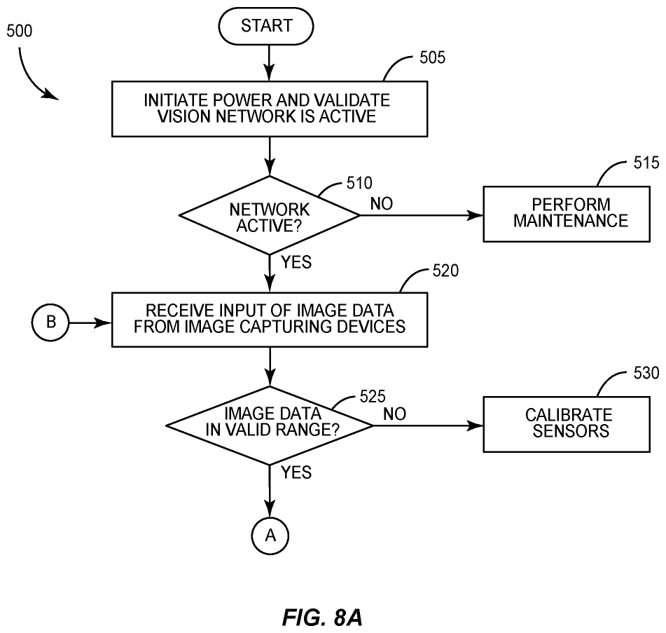

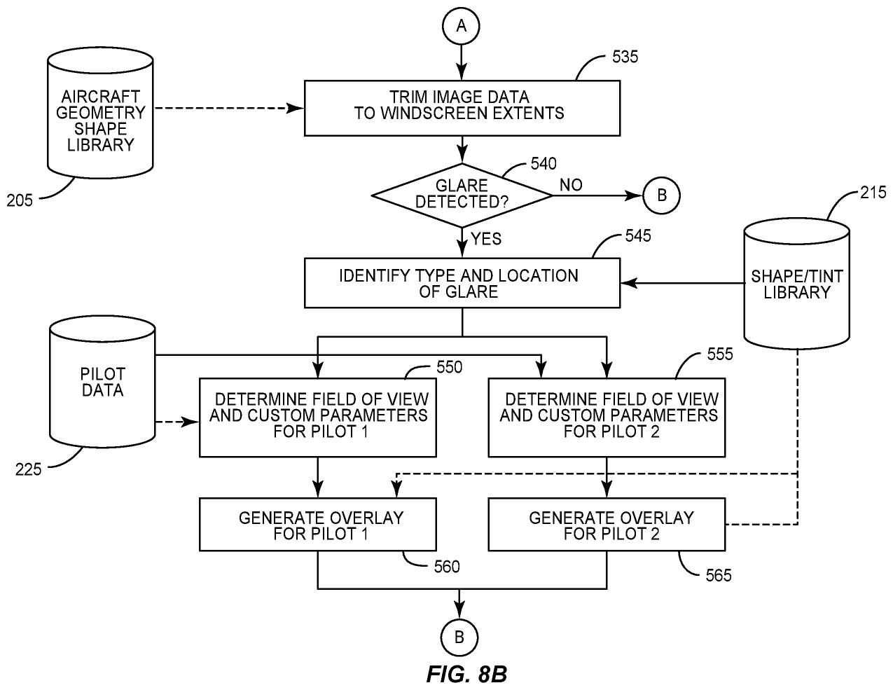

FIGS. 8A and 8B illustrate another exemplary method for reducing glare on an OSTD.

### DETAILED DESCRIPTION

FIG. 1 illustrates a view from inside the flight deck in an aircraft 10. A pilot and co-pilot, referred collectively as pilots, are seated in the flight deck and are looking through the windscreen 12 of the aircraft 10. The pilots in aircraft 10 each wear a head-mounted OSTD 300 that allows the pilots to view the environment around the aircraft 10 using their natural vision. An exemplary OSTD 300 is the HOLOLENS by Microsoft. The OSTD 300 further allows information to be projected into their respective fields-of-view. In FIG. 1, the views of the pilots are obscured by sun glare on the windscreen 12. The presence of sun glare not only prevents the pilots from viewing the scene in front of the aircraft 10, which presents a safety hazard, but may also prevent the pilots from reading the information displayed on the OSTD 300.

According to one aspect of the present disclosure, an anti-glare system 50 is provided to detect the presence of glare in the field of view of the pilots and to generate a shading overlay 20 on the OSTD 300 to block or reduce the glare as shown in FIG. 2.

FIG. 3 illustrates the main functional components of the anti-glare system 50 according to one embodiment. The main components of the anti-glare system 50 comprise an onboard vision system 100, an image processing system 200, and one or more optical see-through displays 300.

The onboard vision system 100 comprises a plurality of image capturing devices 105 for capturing the scene in front of the aircraft 10. In one embodiment, the image capturing devices 105 comprise an array of video cameras disposed around the windscreen 12 of the aircraft 10 as shown in FIG. 4. Additional image capturing devices 105 may be disposed inside the flight deck to capture the view through the windscreen 12 of the aircraft 10. In some embodiments, the image capturing devices 105 can be mounted on the OSTDs 300s worn by the pilots.

The raw image data captured by the image capturing devices 105 is input to the image processing system 200. The main functions of the image processing system 200 are to detect the presence of glare in the field-of-view of the pilots, and to generate a shading overlay to block or reduce the glare. The image processing system 200 may be implemented by one or more microprocessors, hardware, firmware, or a combination thereof. In one embodiment, the image processing system 200 comprises a trimming module 210 to reduce the amount of the raw image data acquired by the image capturing devices 105, a glare detection module 220 to detect glare in the field-of-view of the pilots, and a glare reduction module 230 to generate an overlay 20 on the OSTD 300 as hereinafter described.

The trimming module 210 has access to an Aircraft Geometry Shape Library 205 indexed by type and model of aircraft 10. The Aircraft Geometry Shape Library 205 contains a geometric definition of the windscreen 12 for each aircraft type and model. The windscreen definition for each type and model of aircraft 10 describes the shape and boundaries of the windscreen 12 in three-dimensions. The trimming module 210 correlates the raw image data with the windscreen definition and “trims” or discards the raw image data that is beyond the extent of the windscreen boundaries, i.e. outside a zone of interest. Thus, the windscreen 12 boundaries is used to define a zone-of-interest in the raw image data that contains the field-of-view of the pilots. Those skilled in that art will appreciate that the zone-of-interest may be larger than the actual field-of-view of the pilots to allow for some variation in head position and viewing direction. Trimming the image data reduces the time and amount of processing required to detect glare.

The raw image data corresponding to the zone of interest is input to the glare detection module 220. The glare detection module 220 is configured to detect the presence of glare in the images captured by the image capturing devices 105. Any known techniques can be used to detect glare in the images. In one embodiment, the glare detection module 220 detects glare based on the intensity of the pixels in the image. For example, glare can be detected by comparing the intensity of each image pixel to a threshold. The threshold can be a predetermined threshold, or can be determined dynamically based on an average intensity value of the pixels in the image.

The glare detection module 220 further includes logic to classify the glare by type. For example, the glare can be diffuse or concentrated. Also, the glare may vary in its intensity. Exemplary types of glare conditions include sun glare, glare from man-made light sources, reflections from reflective or mirror-like surfaces, and concentrated beams, i.e., laser lights.

The glare detection module 220 has access to a Shape/Tint Library 215 that contains a catalog of different shapes (e.g. circle, ellipse, square, etc. . . . ) and tints (e.g. light, medium, dark, very dark) for generating overlays 20 to reduce the glare. If glare is detected, the glare detection module 220 compares each high-glare condition to one or more candidate shapes in the Shape/Tint Library and matches the high-glare condition to the closest shape. The glare detection module 220 also determines an appropriate tinting to counteract the high-glare condition based on the intensity and type of the glare. The glare detection module 220 provides information regarding the location of the glare, the shape of the glare, and the tinting requirements to the glare reduction module 230.

The glare reduction module 230 is configured to generate an overlay 20 on the windscreen 12 or head-mount OSTD 300 to block or reduce the detected glare. For each of the pilots, the glare reduction module 230 determines the position of the overlay 20 on the windscreen 12 or head-mounted OSTD 300 to block or reduce the glare. Because the pilots are seated at different locations within the flight deck, and can be different heights, the line-of-sight (LOS) for each pilot will be different. Parameters affecting the LOS of the pilots, such as the pilot's location within the flight deck and the pilot's height, is stored in a pilot database 225 as LOS parameters. The glare reduction module 230 uses the location of the glare provided by the glare detection module and the LOS parameters stored in the pilot database 225 to determine the position of the overlay 20 on the OSTD 300 needed to block the glare.

When the overlay 20 is being generated on a head-mounted OSTD 300, the head movement of the pilots is also tracked and used to determine the position of the overlay 20 on the head-mounted OSTD 300. For example, a pilot may turn his/her head from side to side, which will change the position of the glare on the head-mounted display as shown in FIGS. 5A and 5B. FIG. 5A shows the position of the glare on the OSTD 300 when the pilot is looking forward. FIG. 5B shows the position of the glare on the OSTD 300 when the pilots turns his/her head to the left. A pilot may also look up or down, which will also change the position of the glare on the head-mounted display. The OSTDs 300 typically include accelerometers or other sensors to track the head movement of the pilot. The head movement parameters are provided to the glare reduction module 230 for use in determining the location of the overlay 20 on head-mounted display.

The glare reduction module 230 provides information about a desired shape, color, transparency and position of the overlay 20 to display controller 330 that is operative to render the overlay 20 on the OSTD 300. Referring to FIG. 6, the OSTD 300 comprises an OSTD layer 310 combined with a shading layer 320 on which the overlay 20 is generated. The OSTD layer 310 comprises a conventional OSTD that enables information to be projected into the field-of-view of the pilots. The shading layer 320 comprises a transmissive display, such as a liquid crystal display (LCD), having pixels that can be selectively activated to block the transmission of light. The display controller 330 controls the individual pixels of the transmissive display to generate an overlay 20 with a desired shape, color and transparency at a desired position on the shading layer 320. Various degrees of transparency can be realized by varying the density of the activated pixels. For example, an opaque overlay 20 can be generate by activating all pixels of the masking display within a given area. An overlay 20 with 50% transparency can be generated by activating one-half of the pixels in a given area. The position of the overlay 20 is constantly updated responsive to the motion of the vehicle and the head movement of the pilot. Thus, the overlay 20 may appear from the perspective of the pilot to float on the surface of the OTSD 300.

In some embodiments, the pilot database 225 stores, in addition to the LOS parameters for each pilot, other custom parameters to customize the overlay 20 to suit individual pilot preferences. For example, the pilot database 225 can store the pilots' preferences regarding a shape, color, transparency level, and other attribute of the overlay 20. These custom parameters can be accessed and used by the glare reduction module 230 to adapt the overlay 20 for the pilot's individual preferences. The custom parameters can be different for each pilot.

FIG. 7 illustrates an exemplary method 400 implemented by an anti-glare system 50 according to an embodiment. The method 400 is performed continuously when the anti-glare system 50 is active. The anti-glare-glare system 50 acquires image data of a scene visible to a pilot through the windscreen 12 of the aircraft 10 (block 410). The image data can be acquired, for example, from video camera mounted on the exterior of the aircraft 10, within the flight deck of the aircraft 10, or both. The anti-glare system 50 determines boundaries of the windscreen 12 from geometric data representing the windscreen 12 in three dimensions (block 420), and correlates the image data with the boundaries of the windscreen 12 to determine image data within a zone of interest (block 430). The zone of interest includes the scene as viewed by the pilot through the windscreen 12. The anti-glare system 50 further process the image data representing the zone of interest to detect glare (block 440). If glare is detected, the anti-glare system 50 generates, based on the location of the glare and a field of view of the pilot, an overlay 20 on an OSD 300 to reduce the glare (block 450).

In some embodiments of the method 400, generating an overlay 20 on an OSD 300 to reduce glare further comprises determining a type of the glare, and selecting a shape of the overlay 20 based on the location and type of the glare.

In some embodiments of the method 400, generating an overlay 20 on an OSD 300 to reduce glare further comprises determining one or more custom parameters, and adjusting one or more attributes of the overlay 20 based on custom parameters. For example, the anti-glare system can adjusting at least one of color, level of transparency or shape based on the custom parameters.

In some embodiments of the method 400, acquiring image data of a scene visible to a pilot through the windscreen 12 of the aircraft 10 comprises acquiring image data from one or more video camera disposed around the windscreen 12.

In some embodiments of the method 400, the OSD 300 comprises the windscreen 12 of the aircraft 10.

In other embodiments of the method, optical see-through display comprises a head-mounted, OSD 300.

In some embodiments of the method 400, generating an overlay 20 on an OSD 300 to reduce glare comprises generating a first overlay 20 for a first OSD 300 used by a first pilot; and generating a second overlay 20 for a second OSD 300 used by a second pilot.

FIGS. 8A and 8B illustrate a more detailed method 500 performed by the anti-glare system 50. When the anti-glare system 50 is powered up, a check of the vision network 100 is performed to validate that the vision network 100 is active (block 505, 510). If the vision network is not active, maintenance is performed or scheduled for the vision network (block 515). If the vision network 100 is validated as active, the vision network 100 begins receiving video signals from the image capturing devices 105. As previously noted, the video signals are received continuously while the system is active. As the video signals are received, the vision network 100 checks that the signals are in a valid range (block 525). If not, calibration of the sensors needs to be performed (block 530).

Assuming that the vision network 100 is functioning properly, the raw video signals acquired by the vision network are input to the image processing system 200. The image processing system 200 trims the received video signals to the windscreen extents as previously described using a windscreen definition from the Aircraft Geometry Shape Library 205 (block 535). Following the trimming operation, the image processing system 200 scans the video signal corresponding to the zone of interest to detect glare (block 540). If no glare is detected, processing returns to block 520 for more video signals.

If glare is detected, the image processing system 200 identifies the type and location of the glare in the video signal (block 545). The image processing system 200 additionally determines the field of view and custom parameters for each pilot (blocks 550, 555). Based on the location of the glare and the field of view of the pilots, the image processing system 200 generates an overlay 20 for each of the pilots (blocks 560, 565), which are rendered on the shading layer of the OSD 300. Processing then returns to block 520 for more video signals.

The techniques described herein improve aircraft safety by reducing or minimizing glare from any source. Additionally, the techniques herein described allow the pilot to more easily read information displayed to the pilot on the OSD 300.

1. A method of reducing glare on a windscreen of an aircraft, said method comprising:
acquiring image data of a scene visible to a pilot through the windscreen of the aircraft;
determining boundaries of the windscreen from geometric data representing the windscreen in three dimensions;
correlating the image data with the boundaries of the windscreen to determine a zone interest including a portion of the scene visible to the pilot through the windscreen;
detecting glare in zone of interest; and
generating, based on location of the glare and a field of view of the pilot, an overlay on an optical see-through display to reduce glare.

2. The method of claim 1 wherein generating an overlay on an optical see-through display to reduce glare further comprises:
determining a type of the glare; and
selecting a shape of the overlay based on the location and type of the glare.

3. The method of claim 1 wherein generating an overlay on an optical see-through display to reduce glare further comprises:
determining one or more custom parameters; and
adjusting one or more attributes of the overlay based on custom parameters.

4. The method of claim 3 wherein adjusting one or more attributes of the overlay based on pilot-specific preferences comprises adjusting at least one of color, level of transparency or shape.

5. The method of claim 1 wherein acquiring image data of a scene visible to a pilot through the windscreen of the aircraft comprises acquiring image data from one or more video camera disposed around the windscreen.

6. The method of claim 1 wherein the optical see-through display comprises the windscreen of the aircraft.

7. The method of claim 1 wherein the optical see-through display comprises a head-mounted, optical see-through display.

8. The method of claim 1 generating an overlay on an optical see-through display to reduce glare comprises:
generating a first overlay for a first optical see-though display used by a first pilot; and
generating a second overlay for a second optical see-though display used by a second pilot.

9. An apparatus for reducing glare in the windscreen of an aircraft, said apparatus comprising:
a vision system configured to acquire image data representing a scene visible to a pilot through the windscreen of the aircraft;
an image processor configured to:
determine boundaries of the windscreen from geometric data representing the windscreen in three dimensions;
correlate the image data with the boundaries of the windscreen to determine a zone of interest including the scene visible to the pilot through the windscreen;
detect glare in the zone of interest; and
generate, based on a viewpoint of the pilot, an overlay on an optical see-through display to reduce glare.

10. The apparatus of claim 9 wherein the image processor is further configured to select a shape of the overlay based on a type of the glare.

11. The apparatus of claim 9 wherein the image processor is further configured to:
determine one or more custom parameters selected by the pilot; and
adjust one or more attributes of the overlay based on custom parameters.

12. The apparatus of claim 11 wherein the image processor is configured to adjust at least one of color, level of transparency or shape of the overlay based on the custom parameters.

13. The apparatus of claim 9 wherein acquiring image data of a scene visible to a pilot through the windscreen of the aircraft comprises acquiring image data from one or more video cameras disposed around the windscreen.

14. The apparatus of claim 9 wherein the optical see-through display comprises the windscreen of the aircraft.

15. The apparatus of claim 9 wherein the optical see-through display comprises a head-mounted, optical see-through display.

16. The apparatus of claim 9 generating an overlay on an optical see-through display to reduce glare comprises:
generating a first overlay for a first optical see-though display used by a first pilot; and
generating a second overlay for a second optical see-though display used by a second pilot.
